(19) United States
(12) Patent Application Publication
(10) Pub. No.: US 2026/0128694 A1
(43) Pub. Date: May 7, 2026

(54) SAFE START OF AN AC MOTOR

(71) Applicant: ABB Schweiz AG, Baden (CH)

(72) Inventors: Joakim Lindgren, Västerås (SE); Erik Thenander, Västerås (SE)

(21) Appl. No.: 19/118,989

(22) PCT Filed: Oct. 11, 2022
(86) PCT No.: PCT/EP2022/078219

§ 371 Date: Apr. 7, 2025

(51) Int. Cl. H02P 21/34; H02P 21/12; H02P 21/14; H02P 27/14

(52) U.S. Cl. CPC H02P 21/34; H02P 21/12; H02P 21/14; H02P 27/14

(57) ABSTRACT

A method for safely starting an alternating-current, AC, motor from a pre-loaded stationary condition, the method including: applying a brake to immobilize the AC motor's axle; feeding the AC motor with a predefined drive signal waveform configured not to generate torque and sensing resulting stator currents; comparing the sensed stator currents with reference currents associated with the drive signal; and enabling release of the brake in response to finding that the sensed stator currents match the reference currents.

### TECHNICAL FIELD

The present disclosure relates to the field of electric motors and more precisely to a method for safely starting an alternating-current (AC) motor from a pre-loaded stationary condition.

### BACKGROUND

Various types of internal failures can render an electric motor unable to provide its nominal torque. The seriousness of such a failure is dependent on the nature of the applications where the electric motor is installed. For example, if the failing motor drives a fan, pump or blower, the failure may have limited consequences. In contrast to such use cases, the failure of an electric motor in a robot, elevator or crane motor could be very destructive and even lead to bodily injury. In a robotic use case, potential sources of failure could include:
broken insulated-gate bipolar transistor (IGBT) used for voltage generation,
wrong motor cable connected between controller and robot,
broken motor cable between controller and robot,
broken motor windings,
broken current measurement sensors,
excessive stator resistance,
leakage inductance.

US20180254729A1 discloses a method for ensuring that an electric motor provides sufficient starting torque before a brake is released. This is achieved by compensating an insufficiency in starting torque, to the extent it is due to a voltage drop, by applying a compensation voltage.

Similarly, JP2011254596A discloses a method for improving the rise of magnetic flux in an induction motor, and initiating the start-up of the induction motor in an optimal state with a sufficient torque produced.

While these prior art methods propose ways of ensuring that a desired torque is generated in a braked state of the electric motor, it would be desirable—especially with regard to some use cases in robotics—to carry out a health check on the motor while in a passive condition.

### SUMMARY

One objective of the present disclosure is to propose a motor control method and a motor controller suitable for safely starting an AC motor from a pre-loaded stationary condition. It may be considered safe to start the AC motor, in this sense, after it has successfully passed a health check. A further objective of this disclosure is to propose a motor control method and motor controller by which the correct functioning of the AC motor can be verified while the AC motor is in a torque-free condition. A still further objective is to propose such a motor control method and motor controller suitable for starting an AC motor installed in an industrial robot.

At least some of these objectives are achieved by the invention as defined by the independent claims. The dependent claims relate to advantageous embodiments of the invention.

In a first aspect of the present disclosure, there is provided a method for safely starting an AC motor from a pre-loaded stationary condition. The method comprises: applying a brake to immobilize the AC motor's axle; feeding the AC motor with a predefined drive signal waveform configured not to generate torque and sensing resulting stator currents during such feeding; comparing the sensed stator currents with reference currents associated with the drive signal; and enabling release of the brake if it is found that the sensed stator currents match the reference currents.

According to the first aspect, because the AC motor is fed with a drive signal waveform configured not to generate torque, the comparison as to whether the sensed stator currents match the reference currents associated with the drive signal can be carried out in a rotation-free and substantially torque-free condition of the AC motor. The applied brake therefore does not have to absorb any electrically induced torque, and it is not exposed to the mechanical wear that would result. Accordingly, the braking serves primarily to immobilize the axle against the action of torques exerted by the self-weight of machinery in which the AC motor is installed, and/or from external forces on such machinery. When the machinery is a robot arm, the external forces could include a gravity force that acts on a load or various elastic forces during the gripping of a workpiece.

As used herein, the act of “enabling release of the brake” could correspond to granting a (human or automated) operator of the AC motor the ability to release the brake at the operator's discretion. Enabling release shall not be understood as implying that the brake is necessarily released upon a positive finding, which could be unsafe unless the AC motor is controlled to apply a suitable starting torque. A starting torque value could be considered suitable in this sense if it corresponds approximately to the load on the motor axle that the brake is currently holding.

If it is found that the sensed stator currents match the reference currents, some important classes of failures in the AC motor can be ruled out, and it may therefore be considered safe to start the motor. The qualifier “safe”, as used in the present disclosure, is not to be understood in an absolute sense, or to refer to a certainty that each and every failure scenario can be ruled out if the comparison is successful.

In some embodiments, the predefined drive signal waveform is provided on the basis of a condition that the Q component in a rotor-synchronous DQZ reference frame shall be substantially equal to zero. By definition, a rotor-synchronous DQZ reference frame (or rotating reference frame) is aligned with the rotor phase at all times: it rotates with the rotor of the AC motor, and it is stationary while the AC motor is. In these embodiments, the nonzero component of the predefined drive signal waveform may have either polarity. More precisely, in a permanent-magnet motor (PMSM), the nonzero component may be parallel or antiparallel to the rotor magnets, thereby either strengthening or weakening the permanent magnetic field.

In some embodiments, the release of the brake is enabled in response to finding that the absolute error between the sensed stator currents and the reference currents is below a threshold. This provides a simple and robust criterion for determining whether the sensed stator currents match the reference currents. If the absolute error between the sensed stator currents and the reference currents is found to exceed the threshold, release of the brake remains disabled.

In some embodiments, an error indication may be provided in response to finding that the sensed stator currents do not match the reference currents. The error condition may be a human-perceptible signal, or a message to a controlling processor or software application.

In some embodiments, the comparison of the sensed stator currents and the reference currents includes converting the stator currents from a stationary reference frame into a rotor-synchronous reference frame (or rotating reference frame), such as the DQZ frame mentioned above. In other words, the DQZ frame is stationary while the AC motor's axle is immobilized. The conversion into the DQZ frame allows a precise and meaningful comparison of the actual stator currents and the reference currents associated with the predefined drive signal waveform.

In a second aspect of the present disclosure, there is provided a motor controller arranged to control an electric drive unit which feeds an AC motor. The motor controller has processing circuitry configured to apply a brake to immobilize the AC motor's axle; to feed the AC motor with a predefined drive signal waveform configured not to generate torque and to sense resulting stator currents; to compare the sensed stator currents with reference currents associated with the drive signal; and to enable release of the brake in response to finding that the sensed stator currents match the reference currents.

The invention further relates to a computer program containing instructions for causing a computer, or the motor controller in particular, to carry out the above motor control method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 is a transverse cross section of a permanent-magnet synchronous motor (PMSM);

FIG. 2 introduces quantities in a rotor-synchronous DQZ reference frame;

FIG. 3 is a block diagram representation of a motor controller connected, over an electric drive unit, to an AC motor;

FIG. 4 is a flowchart of a motor control method according to embodiments herein; and

FIG. 5 illustrates successive signal processing steps occurring in the motor control method of FIG. 4.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

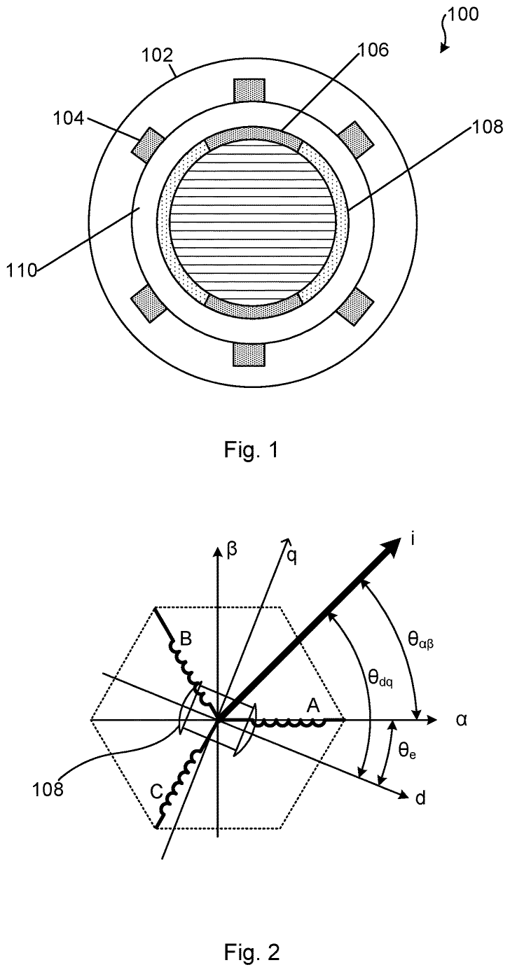

FIG. 1 is a transverse cross section of a permanent-magnet synchronous motor (PMSM) 100. PMSM is one type of alternating-current (AC) motor within the scope of applicability of the present disclosure. In general, PMSMs can be categorized as surface-mounted PMSMs or interior-mounted PMSMs. FIG. 1 is a simplified diagram of an example surface-mounted PMSM, which comprises a rotor 108 configured to rotate within a stator 102. The stator 102 includes a number of electrical windings 104 arranged to surround the rotor 108. For surface-mounted PMSMs, permanent magnets 106 are mounted on the surface of the rotor 108. During operation, electrical current through the windings 104 establishes a magnetic field within the air gap 110 between the rotor 108 and the stator 102, and the interaction between the magnets 106 and the magnetic field causes the rotor 108 to rotate, producing torque. The speed and direction of the rotor 108 can be controlled by controlling the current through the stator windings 104. Interior-mounted PMSMs are similar to surface-mounted PMSMs, except that the permanent magnets 106 are buried within the rotor 108 rather than being mounted on the surface. FIG. 1 shows an example PMSM 100 with a single rotor pole and three stator poles. The axial direction of the PMSM 100 can be imagined orthogonal to the plane of the drawing.

The teachings of the present disclosure can also be advantageously applied to several further types of AC motors, including induction motors. It is recalled that the magnetization of the rotor in an induction motor is not static but is induced by currents opposing the stator's magnetic field. The rotor currents flow in short-circuited rotor windings, which may have a wound or squirrel-cage circuit topology. It is recalled that unlike synchronous motors like the PMSM, an externally loaded induction motor rotates slightly slower than the stator field (slip).

FIG. 2 is a schematic drawing illustrating the rotor-synchronous DQZ reference frame, which is a way of representing currents flowing in a AC motor, such as a PMSM or induction motor. The AC motor has three equidistant stator windings A, B, C arranged at equal pole angles, in which respective stator currents i_{A}, i_{B}, i_{C} can flow. The AC motor also comprises a rotor 108. The DQZ reference frame can be used with an AC motor with a higher number of stator poles too, wherein the individual stator currents are obtainable as linear combinations of i_{A}, i_{B}, i_{C}. The orthogonal axes α, β are stationary relative to the stator (i.e., stator-synchronous), and the orthogonal direct and quadrature axes d, q are stationary relative to the rotor 108 (i.e., rotor-synchronous). The direction of the d axis is parallel to the rotor 108 magnetization in a PMSM.

A triplet (i_{A}, i_{B}, i_{C}) of momentary stator currents without any common-mode component can be expressed as a vector i=(i_{D}, i_{Q}) in the d, q plane. In the present disclosure, the first and second components of i will be referred to as the direct (D) component and the quadrature (Q) component. The angles indicated in FIG. 2 are:
momentary rotor angle θₑ (i.e., the angle between the α, β and d, q reference frames),
stator-current phase angle θ_{αβ} in the stator frame, and
stator-current phase angle θ_{dq} in the rotor frame.
   The DQZ vector for a stator current triplet (i_{A}, i_{B}, i_{C}) which has a common-mode variation will additionally include a positive or negative so-called zero (Z) component i_{Z}. The transformation between the ABC and DQZ frames,

$$[ \begin{matrix}{i}_{D} \\ {i}_{Q} \\ {i}_{Z}\end{matrix} ] = {K}_{CP} [ \begin{matrix}{i}_{A} \\ {i}_{B} \\ {i}_{C}\end{matrix} ] ,$$

corresponds to the matrix

$${K}_{CP} = \sqrt{\frac{2}{3}} [ \begin{matrix}cos {θ}_{e} & cos ( {θ}_{e} - \frac{2 π}{3} ) & cos ( {θ}_{e} + \frac{2 π}{3} ) \\ - sin {θ}_{e} & - sin ( {θ}_{e} - \frac{2 π}{3} ) & - sin ( {θ}_{e} + \frac{2 π}{3} ) \\ \frac{1}{\sqrt{2}} & \frac{1}{\sqrt{2}} & \frac{1}{\sqrt{2}}\end{matrix} ]$$

where θₑ is the momentary rotor angle. The inverse transformation corresponds to

$${K}_{C P}^{- 1} = {K}_{CP}^{T} .$$

For additional details, reference is made to B. Adkins and R. G. Harley, The General Theory of Alternating Current Machines: Application to Practical Problems, Chapman and Hall, London, 1975.

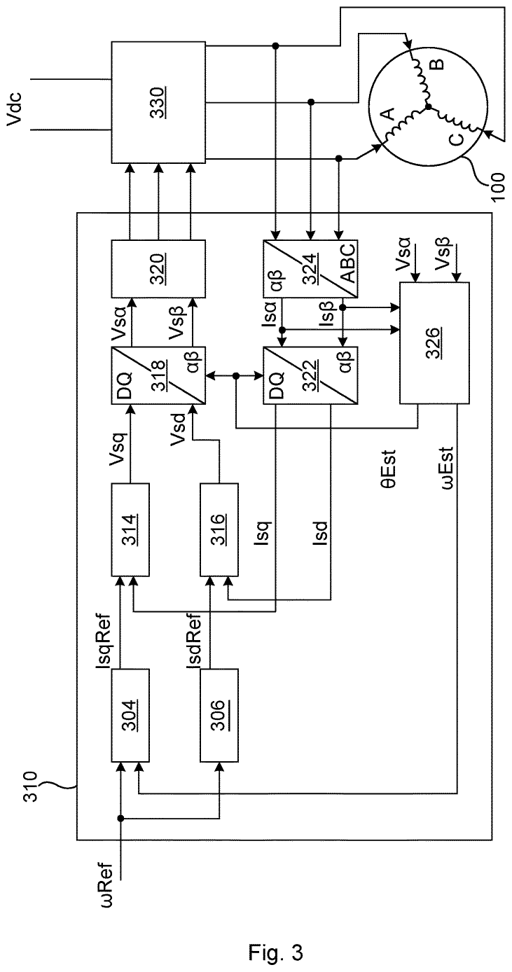

FIG. 3 shows an example configuration for a motor controller 310. The motor controller 310 can be implemented as part of a motor drive (e.g., a variable-frequency drive) that controls motion of an AC motor 100 in accordance with a speed reference signal ωRef provided by a supervisory motion control application or system (not shown). In other configurations, the motor controller 310 may be implemented on one or more processing chips as part of an embedded system for controlling an AC motor 100. In yet another configuration, the motor controller 310 can be implemented as part of a motor control module of an industrial controller for control of an AC motor 100 used in an industrial motion control system. It is to be appreciated that the techniques disclosed herein are not limited to these implementations.

In this example, the AC motor 100 is a sensorless motor whose motion is controlled by the motor controller 310. In operation, the motor controller 310 controls the AC motor 100 using a flux control loop and a torque control loop. Torque reference IsqRef and the flux reference IsdRef represent target references for the quadrature (Q) and direct (D) components, respectively, of the stator currents. To provide feedback for the flux and torque control loops, the motor controller 310 measures the three stator currents (i_{A}, i_{B}, i_{C}), as shown in the lower right portion of FIG. 3. Alternatively, the measurements can be made on two phases of the three-phase AC power delivered to the AC motor 100, wherein the current for the third phase is calculated based on the values of the other two phases. A transformation block 324 transforms the stator current measurements from the three-phase A, B, C reference to the stationary α,β coordinate framework (e.g., by a Clarke transformation) to yield Isα and Isβ. A further transformation block 322 transforms Isα and Isβ to the rotor-synchronous d,q coordinate framework (e.g., a Park transformation) to yield Isq and Isd. An Iq control block 314 and an Id control block 316 compare the values of Isq and Isd to their corresponding reference values IsqRef and IsdRef, and adjust reference voltage values Vsq and Vsd based on any detected errors between the measured values Isq and Isd and their corresponding reference values IsqRef and IsdRef. The adjustment may follow a P, PI, PD, PID or similar control law.

A transformation block 318 transforms Vsq and Vsd from the rotary d,q framework to the stationary α,β framework (e.g., an inverse Park transform) to yield Vsα and Vsβ. Based on these values, a control signal output block 320, such as a space vector modulation (SVM) component or pulse width modulation (PWM) component, controls the AC output of an electric drive unit 330, thereby indirectly controlling motion of the AC motor 100. The electric drive unit 330 may be powered by a direct current Vdc.

If closed-loop sensorless control is used, then during operation an estimation component 326 estimates the speed of the AC motor 100 based on measured stator currents Isα and Isβ and reference voltage values Vsα and Vsβ. The estimated velocity ωEst is compared with the speed reference ωRef (received from an external source, such as an operator interface or a separate motion control application), and a speed control component 304 adjusts IsqRef as needed based on detected errors between the speed reference ωRef and the estimated velocity ωEst. An optional field-weakening (flux-weakening) control component 306 controls the value of the flux reference IsdRef. Additionally, the estimation component 326 provides an estimate θEst of the rotor angle θₑ and feeds this to the transformation blocks 318, 322.

As an alternative to sensorless control, the motor controller 310 may measure the actual speed of the AC motor 100 directly, rather than estimating the speed using the estimation component 326. For such sensing, an angle sensor (rotary encoder) may replace the estimation component 326.

It is understood that the various components and blocks in FIG. 3 can correspond to respective dedicated hardware units (e.g., chipsets) or software units (e.g., procedures, modules), or a multifunctional hardware or software unit.

The present disclosure provides a method 400 of operating a motor controller 310 of the type exemplified with reference to FIG. 3 for facilitating a safe start of the connected AC motor 100. The method 400 can be implemented, at least in part, by a human operator or it can be automated. For example, the method 400 can be expressed as machine-readable instructions to be executed by the motor controller 310.

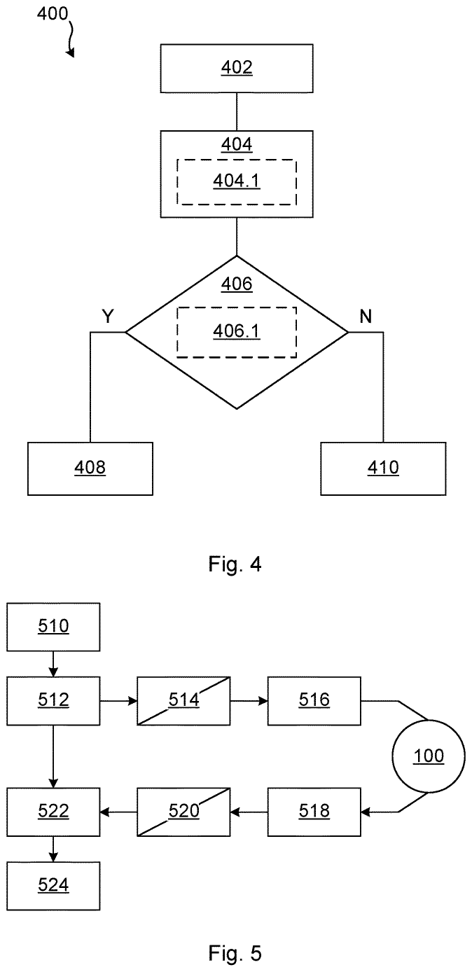

The method 400 includes, as shown in FIG. 4, an initial step 402 of applying a brake to immobilize the AC motor's axle. The brake can be a frictional brake, such as a drum brake or disc brake, or a form-locking brake. It need not be designed for dissipative braking (e.g., with an ability to thermally dissipate a significant amount of kinetic energy); rather an ability to exert static or holding forces is sufficient for the purposes of executing the present method 400. More precisely, the onset of the brake can occur in a non-rotating condition of the AC motor's axle. The brake may be a component in an integrated robot-arm servo motor, which is operable to exert a torque at a robot-arm joint while energized and to maintain the joint stationary at other times.

In a second step 404, the AC motor 100 is fed with a predefined drive signal waveform configured not to generate torque. The resulting stator currents (i_{A}, i_{B}, i_{C}) are sensed while this drive signal is being applied. As noted, the stator currents may be sensed at all three phases or derived from two phases. With reference to FIG. 3, the drive signal can be expressed in terms of the (IsqRef, IsdRef), (Vsq, Vsd) or the (Vsα, Vsβ) components, that is, in the rotor-synchronous or stator-synchronous reference frame.

In a rotor-synchronous reference frame, such as DQZ, zero torque generation may be ensured by providing the drive signal waveform based on a zero setpoint value of the quadrature component, Vsq=0 or IsqRef=0. Meanwhile, the polarity of the direct component Vsd or IsdRef is generally arbitrary as regards torque generation. The polarity may be assigned based on what is deemed suitable for the AC motor installation as a whole. In the particular case of a PMSM, the predefined drive signal waveform may be either field-strengthening (Vsd≥0) or field-weakening (Vsd≤0), that is, generating a vector which is parallel or antiparallel to the permanent magnetization of the rotor 108.

In a third step 406, the sensed stator currents (i_{A}, i_{B}, i_{C}) are compared to reference currents associated with the drive signal. For example, the comparison task may be carried out by the Iq control block 314 and Id control block 316 if configured accordingly.

To enable a more meaningful comparison, the stator currents (i_{A}, i_{B}, i_{C}) may be converted 406.1 from a stationary reference frame into a rotor-synchronous reference frame, which is aligned with the current position of the rotor 108. The conversion (or transformation) may for example be carried out by the transformation blocks 322, 324 described above, which output the pair (Isd, Isq). The pair (Isd, Isq) is compared 406 to the pair (IsdRef, IsqRef), which is used as reference currents. Alternatively, the reference currents can be computed by scaling the reference voltage values (Vsd, Vsq) by a known or estimated stator resistance.

In a fourth step 408 of the method 400, it is determined whether the sensed stator currents (as converted, if step 406.1 is included) match the reference currents. If the determination returns a positive outcome, the AC motor 100 is considered safe to start, and the release of the brake is enabled.

The comparison 406 preceding the determination in step 408 may be based on one or more thresholds L, L_{d}, L_{q} on an absolute error of these currents. The absolute error can be a collective error, such as

(Isd−IsdRef)²+(Isq−IsqRef)²≤L,

or a pointwise error, such as

$$\{ \begin{matrix}{( Isd - IsdRef )}^{2} \leq {L}_{d} \\ {( Isq - IsqRef )}^{2} \leq {L}_{q}\end{matrix} .$$

Here, the value of the thresholds L, L_{d}, L_{q} can be determined by simulations of healthy and faulty AC motors of the type under consideration. Alternatively, the thresholds can be computed from measurements on specimens of this AC motor type, with and without known defects.

In some embodiments of the method 400, as shown in FIG. 4, a negative outcome of the comparison 406 can trigger the providing 410 of an error indication. The error indication may be provided in human- or machine-readable form, as deemed relevant in the use case at hand.

FIG. 5 illustrates successive signal processing steps which may be performed during the execution of the motor control method 400.

In an initial step 510, a configuration is provided. The configuration may identify all drive axes connected to the drive system. In the case of an industrial robot installation, this could include robot axes and additional drive axes.

In a next step 512, a reference current IsdRef in the magnetizing direction is calculated for all connected drive axes. The reference current IsqRef in the orthogonal direction may be set to zero.

The nonzero direct reference current component IsdRef is converted (transformed), in a further step 514, from the rotor-synchronous reference frame into a stationary reference frame using an inverse Park transform.

Next, in step 516, a voltage to the AC motor 100 is generated. The voltage may be generated using PWM.

In a subsequent step 518, the phase currents (i_{A}, i_{B}, i_{C}) of the stator of the AC motor 100 are measured.

Then, in step 520, the stator currents are converted from the stationary reference frame into a rotor-synchronous reference frame using Clark and Park transforms.

In a comparison step 522, an absolute error between the D-component of the reference current, IsdRef, and the D-component of the measured stator currents is computed.

In step 524, if the absolute error is found to be below a predefined threshold L (which may be configurable to account for variations in local conditions or tolerances), the control loop is considered to be fully functional, and the release of the brake(s) currently immobilizing the AC motor's 100 axle is enabled. Conversely, if the absolute error exceeds the threshold L, the control loop does not pass the health check, and no release of the brake(s) shall be possible.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method for safely starting an alternating-current, AC, motor from a pre-loaded stationary condition, the method comprising:
applying a brake to immobilize the AC motor's axle;
feeding the AC motor with a predefined drive signal waveform configured not to generate torque and sensing resulting stator currents;
comparing the sensed stator currents with reference currents associated with the drive signal; and
enabling release of the brake in response to finding that the sensed stator currents match the reference currents.

2. The method of claim 1, wherein the predefined drive signal waveform has a zero Q component in a rotor-synchronous DQZ reference frame.

3. The method of claim 1, wherein the motor is a permanent-magnet synchronous motor, PMSM.

4. The method of claim 3, wherein the predefined drive signal waveform is field-strengthening in relation to a rotor of the PMSM.

5. The method of claim 3, wherein the predefined drive signal waveform is field-weakening in relation to a rotor of the PMSM.

6. The method of claim 1, wherein the motor is an induction motor.

7. The method of claim 1, wherein the release of the brake is enabled in response to finding that the absolute error between the sensed stator currents and the reference currents is below a threshold.

8. The method of any of claim 1, further comprising:
providing an error indication in response to finding that the sensed stator currents do not match the reference currents.

9. The method of any of claim 1, wherein said comparing the sensed stator currents with the reference currents includes converting the stator currents from a stationary reference frame into a rotor-synchronous reference frame.

10. The method of claim 1, wherein said feeding the AC motor with a predefined drive signal waveform includes performing a phase-width modulation, PWM.

11. The method of claim 1, wherein the AC motor is installed in an industrial robot.

12. A motor controller arranged to control an electric drive unit configured to feed an alternating-current, AC, motor,
the motor controller comprising processing circuitry configured to perform the method of:
applying a brake to immobilize the AC motor's axle;
feeding the AC motor with a predefined drive signal waveform configured not to generate torque and sensing resulting stator currents;
comparing the senses stator currents with reference currents associated with the drive signal; and
enabling release of the brake in response to finding that the sensed stator currents match the reference currents.

13. A computer program comprising instructions to cause a motor controller arranged to control an electric drive unit configured to feed an alternating current,
the motor controller having processing circuitry configured to perform the method of:
applying a brake to immobilize the AC motor's axle;
feeding the AC motor with a predefined drive signal waveform configured not to generate torque and sensing resulting stator currents;
comparing the senses stator currents with reference currents associated with the drive signal; and
enabling release of the brake in response to finding that the sensed stator currents match the reference currents, to execute the steps of the method.

14. The method of claim 2, wherein the motor is an induction motor.

15. The method of claim 2, wherein the release of the brake is enabled in response to finding that the absolute error between the sensed stator currents and the reference currents is below a threshold.

16. The method of any of claim 2, further comprising:
providing an error indication in response to finding that the sensed stator currents do not match the reference currents.

17. The method of any of claim 2, wherein said comparing the sensed stator currents with the reference currents includes converting the stator currents from a stationary reference frame into a rotor-synchronous reference frame.

18. The method of claim 2, wherein said feeding the AC motor with a predefined drive signal waveform includes performing a phase-width modulation, PWM.

19. The method of claim 2, wherein the AC motor is installed in an industrial robot.
